(19) United States
(12) Patent Application Publication
(10) Pub. No.: US 2013/0066805 A1
(43) Pub. Date: Mar. 14, 2013

(54) Method and System for Providing Synthetic Exposure to an Actively Managed Portfolio

(71) Applicants: Michael Garrett, Jersey City, NY (US); Matthew Fleming, New York, NY (US); Michael Davis, New York, NY (US); Warun Kumar, New York, NY (US)

(72) Inventors: Michael Garrett, Jersey City, NY (US); Matthew Fleming, New York, NY (US); Michael Davis, New York, NY (US); Warun Kumar, New York, NY (US)

(21) Appl. No.: 13/595,479

(22) Filed: Aug. 27, 2012

Related U.S. Application Data
(60) Provisional application No. 61/533,492, filed on Sep. 12, 2011.

(51) Int. Cl. G06Q 40/06; G06Q 40/04

(52) U.S. Cl. 705/36 R

(57) ABSTRACT

An investment vehicle tracks the positive returns of actively managed investments without realizing investment return from the actively managed assets directly. This tracking is provided through the purchase of a series of call options linked to the positive performance of the actively managed portfolio as well as supplemental investments, for example, in fixed income instrument to provide a desired volatility to the portfolio of options and supplemental investments.

### CROSS REFERENCE TO RELATED APPLICATION

This application claims the benefit of U.S. provisional application 61/533,492 filed Sep. 12, 2011 and hereby incorporated by reference in its entirety.

### BACKGROUND OF THE INVENTION

The present invention relates to a fund that seeks to track the positive performance of an actively managed portfolio of securities without a direct investment in said portfolio. Through the use of various types of investments, the fund also seeks to outperform the actively managed portfolio in declining markets.

An actively managed portfolio is a portfolio of securities such as stocks, bonds, currencies, commodities, or combinations thereof that are professionally managed in a way to increase returns and/or reduce risk versus an investment in an index or passive basket of securities. These actively managed portfolios may be in the form of a separate account, a mutual fund, a hedge fund, or other vehicle.

The invention may provide particular benefits with respect to investments related to master limited partnerships. A master limited partnership (MLP) is an exchange traded limited partnership investing in certain “qualifying” activities related to natural resource activities such as oil and gas exploration, production and transportation. As used herein, MLP refers to a partnership of the type described above formed under the Tax Reform Act of 1986 and such similar structures as may be formed under amendments to this act. The limited partnership form provides investors the ability to share in the profits of these activities with limited liability to the debts of the partnership. In addition, the limited partnership form allows investors to avoid double taxation at the partnership and investor level. Importantly, the distributions from the MLP to the limited partners are considered a return of capital so taxes can be deferred until the MLP shares are sold.

Many attractive investment opportunities are available principally as MLPs (in part because of the advantage of eliminating double taxation—intended by Congress to promote such investments) and yet investment in MLPs is not practical for several classes of investor including US tax-exempt investors and non-US investors. For US tax-exempt investors, an MLP is considered linked to an activity unrelated to the primary purpose of the tax exempt entity, and income related to this activity is termed “Unrelated Business Taxable Income” (UBTI) and the investor may be liable to file tax returns in every state in which the MLP does business (typically many states). For the non-US investor, returns from the MLPs are considered “Effectively Connected Income” (ECI), again requiring the investor to pay US income tax on distributions and file tax returns in each state in which the MLP does business.

It would be desirable if these investors could participate in investment opportunities that are primarily realizable only through MLPs.

### SUMMARY OF THE INVENTION

The present inventors have developed an investment vehicle that largely tracks the positive returns of actively managed investments without realizing investment return from the actively managed assets directly. This tracking is provided through the purchase of a series of call options linked to the positive performance of the actively managed portfolio as well as supplemental investments, for example, in fixed income instrument to provide a desired volatility to the portfolio of options and supplemental investments.

A call option gives the purchaser the right, but not the obligation, to buy an asset at a predetermined price on a predetermined date. When exercised, the options can be settled by transferring the assets underlying the option or by settling in cash (by the purchaser receiving cash equal to the value of the option upon exercise or maturity). The options can also be sold to another party who may exercise the option providing a similar economic effect to exercise at that date. The options used in this invention will usually be cash settled.

Many options are listed on an exchange such as the Chicago Board Options Exchange (CBOE). Similar options, which can be customized by maturity date, strikes, and other factors, may be purchased from broker-dealers or other financial institutions through the over-the counter market (OTC). The invention contemplates the step of negotiating with multiple broker-dealers or other financial institutions to create total return options on actively managed MLP portfolios, which is something that has not been done previously.

The supplemental investments, for example, fixed income investments, may be aggregated with the call options to offset the inherent leverage of the call options. By properly balancing the call options and the other investments, an investment vehicle that mimics the positive performance of the actively managed portfolio may be generated. The fixed income investments in the investment vehicle provide a different return profile in the event the actively managed portfolio declines, as compared to a direct investment in the actively managed portfolio itself. For significant declines in the actively managed portfolio, the investment vehicle should materially outperform a direct investment, for while the call options in the investment vehicle will decline in value, the fixed income investments should provide stability.

These particular features and advantages may apply to only some embodiments falling within the claims and thus do not define the scope of the invention. The following description and figures illustrate a preferred embodiment of the invention. Such an embodiment does not necessarily represent the full scope of the invention, however. Furthermore, some embodiments may include only parts of a preferred embodiment. Therefore, reference must be made to the claims for interpreting the scope of the invention.

### BRIEF DESCRIPTION OF THE FIGURES

FIG. 1 is a simplified diagram of the operation of a standard MLP showing the flow of tax and dollar benefits to a limited partner but not to excluded classes of investors;

FIG. 2 is a block diagram showing a combination of call options and fixed income investments simulating the performance of the actively managed portfolio; and

FIG. 3 is a simplified flowchart of the steps implemented by an electronic computer in realizing the method of the present invention.

### DETAILED DESCRIPTION OF THE PREFERRED EMBODIMENT

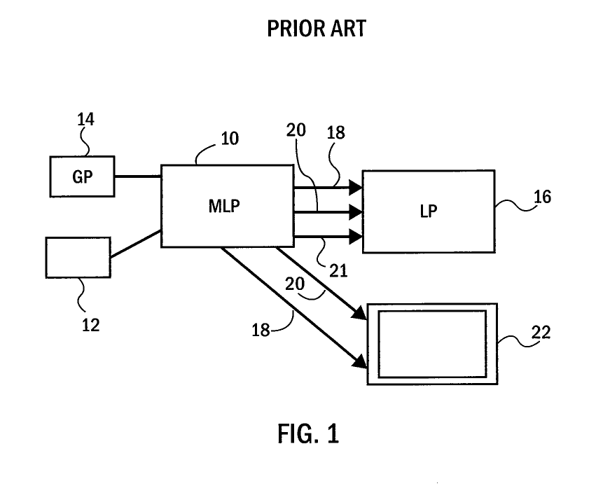

Referring now to FIG. 1, a master limited partnership 10 (MLP) may invest in qualifying activities 12 under the guidance of a general partner 14. The MLP 10 may have one or more limited partners 16 (for example purchasers of shares on an exchange) who realize the benefits of distributions 18 (cash or the like) and MLP-level tax benefits 20, for example, in the form of elimination of double taxation at the level of the MLP 10 and the limited partner 16 and investor-level tax benefits 21 in the form of treating distributions as returned capital. It will be understood that the MLP-level tax benefits 20 accrue to the limited partner 16 to the extent that they reduce the operating costs of the MLP 10.

An excluded investor 22 may also invest in the MLP 10 and will receive the distribution 18 and the MLP-level tax benefits 20 but without the investor-level tax benefits 21 resulting in taxation of the distribution 18 as ordinary income at the time of receipt.

The tax favored treatment provided to MLPs for qualifying activities results in an important class of investment opportunities being accessible only through MLPs. To the extent that the exchange price of the MLP 10 reflects an expectation by purchasers of the investor-level tax benefits 21, the excluded investor 22 may not realize market return for the inherent risk of the investment and thus may be practically excluded from these investment opportunities.

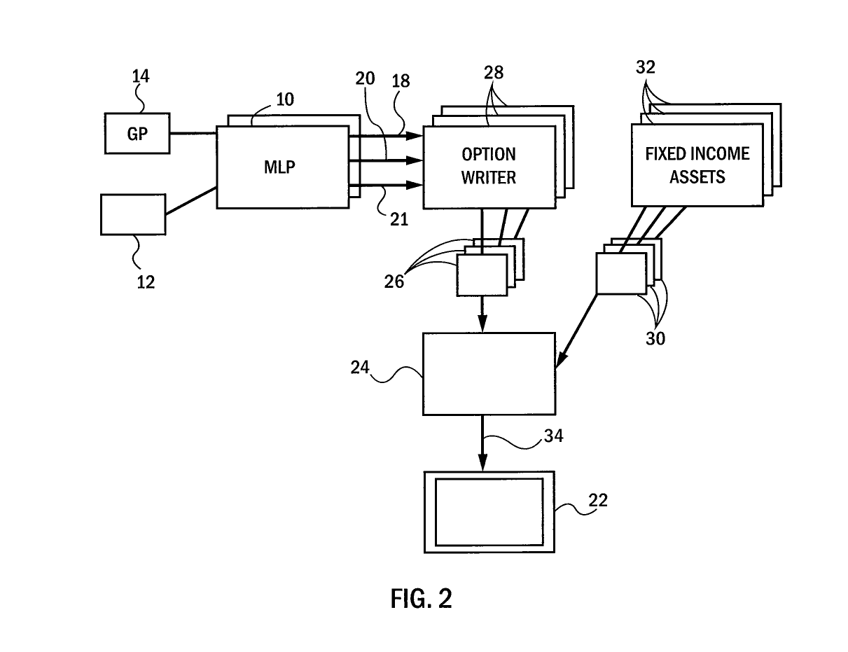

Referring now to FIG. 2, the present invention may be used to provide an investment vehicle 24 that offers investment benefits similar to those of an actively managed portfolio and related to the underlying investment value of the portfolio without actually requiring purchase of the underlying portfolio. Investment vehicle 24 therefore may allow investors 22 to participate in investments that may be problematic to invest in directly, may permit investors 22 to contribute smaller amounts of capital than would otherwise be required for a direct investment and may provide a more advantageous return profile due to the fixed income assets 32 included in the investment vehicle.

The investment vehicle 24 may purchase call options 26 with various maturity dates (for example 2.5, 3, 3.5, and 4 year maturities) that provide the investment vehicle with the positive performance of the actively managed portfolio 10. These call options are typically structured as over-the-counter (OTC) options, which are privately negotiated transactions between the investment vehicle and the option counterparty. The call options are typically purchased from a broker-dealer or other financial services firm and expose the purchaser to the seller's credit risk.

Preferably, the options 26 are obtained from multiple option sellers 28 to diversify this credit risk and will have staggered maturities. Accordingly, options will be purchased and sold or allowed to expire according to a defined schedule. As noted above, the option sellers 28 need not be holders of the actively managed portfolio 10 and generally no limited partnership interest, shares or other underlying property in the actively managed portfolio will be transferred upon exercise or sale of the options.

The options 26 are inherently highly leveraged such as would undesirably increase the volatility of the investment vehicle 24 above the volatility of the actively managed portfolio 10 if they were the only securities held by the investment vehicle. Accordingly this leverage is offset through the purchase of other investments 30 in different instruments 32 unrelated to the actively managed portfolio and call options and ideally being fixed income instruments whose volatility and value may be readily established.

It will be appreciated, that the options 26 will generally capture appreciation in the value of the actively managed portfolio, for example, by setting the strike price of the call option 26 equal to the net asset value (NAV) of the account or pooled vehicle that holds the actively managed portfolio 10, at the time of the option purchase. To the extent that the price of the call options 26 reflect the market value of the shares of the MLPs 10 in the open market to qualified investors who may receive both the distributions 18 and the MLP-level tax benefits 20 and investor-level tax benefits 21, the options 26 capture the full realizable benefits of any appreciation of the underlying qualifying activities 12.

The excluded investors 22 buy shares of the investment vehicle 24 and participate in investment opportunities in the qualifying activities 12 through returns 34 from sales of the investment vehicle 24, realized only upon sale of the investment vehicle 24 and possibly at capital gains rate without a penalty for being an excluded investor 22.

In addition to the application of this technology to actively managed MLP portfolios, synthetic exposure may also be obtained on a hedge fund or separate account managed in the same manner as the hedge fund. Hedge funds often seek to deliver positive performance, regardless of the market environment. Many hedge funds are subject to ‘fat-tails’ (e.g. probability distributions with large skew or kurtosis) and the turnover in their portfolio is often high. Many hedge funds are subject to more risk than traditional models relying on normal distributions of returns predict, which is what ‘fat-tails’ signify. Often, this is due to the leverage and relative illiquidity that many hedge fund managers employ in their strategies. High portfolio turnover creates tax burdens for taxable investors. Because options have a known premium, that premium represents the maximum loss that an investor can receive. In a direct investment, the maximum loss is the total amount invested in the strategy. Options linked to the performance of the hedge fund solve for the issue of the hedge fund incurring significant losses, as the investor in the options would only lose the premium spent on the option, rather than the entire investment in the hedge fund. Additionally, because options are considered capital instruments (and therefore subject to capital gains taxes, not ordinary income taxes), an investor may achieve higher after-tax returns by investing in an option linked to the performance of the hedge fund, rather than the hedge fund directly.

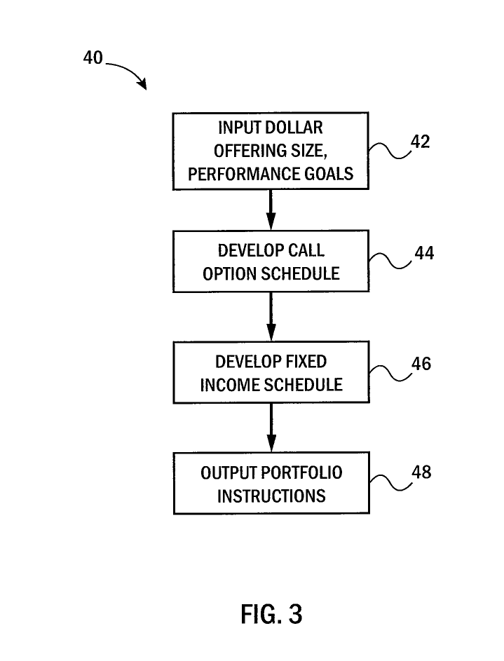

Referring now to FIG. 3, a computer program 40, implementing the method of the present invention may receive input from a user as indicated by process block 42 providing a dollar amount of investment vehicle 24 to be offered together with performance goals, for example, volatility, annualized return, maximum drawdown, and Sharpe ratio. At process block 44 a call option purchase schedule is then generated providing timing and identification of a set of call options 26 to be purchased on the actively managed portfolio. The volatility of the schedule developed at process block 44 is then matched to the performance goals through the purchase of other investments 30 to provide a schedule for such purchases including amounts and investment maturity dates as indicated by process block 46. At process block 48 an output is provided to guide in implementation of the necessary purchases.

The computer program 40, in implementing the method of the present invention will attempt to optimize the amount of exposure the investment vehicle 24 maintains to the actively managed portfolio 10 through the call options 26. Among other calculations, the computer program 40 will compute and monitor the amount of “delta” in the call options 26. The “delta” of the options describes the amount by which the value of the call options will change as the value of the actively managed portfolio changes, and is itself a number that changes over time. At any time the “delta” is calculated using the following formula, or a variation thereon:

delta=N(d₁)

where:

$$N ( {d}_{1} ) = \frac{1}{\sqrt{2 π}} {\int }_{- ∞}^{{d}_{1}} {e}^{- \frac{{z}^{2}}{2}} d z$$

$${d}_{1} = \frac{ln ( \frac{S}{K} ) + ( r + \frac{{σ}^{2}}{2} ) ( T - t )}{σ \sqrt{T - t}}$$

S is the value of the actively managed portfolio
K is the strike price of the call option
r is the risk free interest rate
T−t is the time to maturity
σ is the volatility of returns of the actively managed portfolio

As the delta of the options in the investment vehicle changes (calculated by the program and referred to as the Current Investment Delta), the computer program will create additional call option purchase or sale schedules 44 and fixed income purchase or sale schedules 46 to ensure that the investment vehicle is properly invested. The investment vehicle will have a specified Maximum Investment Delta, Minimum Investment Delta and Target Investment Delta.

If the Current Investment Delta is greater than the Maximum Investment Delta, call options will be sold and fixed income will be purchased such that the Current Investment Delta will then equal the Target Investment Delta. If the Current Investment Delta is less than the Minimum Investment Delta, call options will be purchased and fixed income will be sold such that the Current Investment Delta will then equal the Target Investment Delta.

As will be appreciated to those of ordinary skill in the art, the computer program 40 may be implemented on an electronic computer including for example one or more microprocessor elements communicating with random access and disk memory which comprise a non-transient form of storage in which together may communicate with a monitor and keyboard or other user interface elements and which may communicate with the Internet all for the inputting and outputting of data as has been described.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a computer” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

We claim:

1. A method for creating a fund providing properties similar to an investment in an actively managed portfolio comprising the steps of:
purchasing call options linked to the performance of an actively managed portfolio;
calculating, by an electronic processor executing a program stored in a non-transient medium, a dollar quantity of other investments to offset the inherent leverage of the call options;
providing investors distributions based on profits or losses from the aggregated call options and other investments.

2. The method of claim 1 wherein the call options have a range of expiration dates.

3. The method of claim 1 wherein the call options are purchased from different multiple entities.

4. The method of claim 1 wherein the dollar quantity of other investments needed to offset the inherent leverage of the call options is determined by calculating an amount of delta in the call options describing an amount by which the value of the call options will change as the value of the actively managed portfolio changes.

5. The method of claim 4 wherein the delta is determined as:
delta=N(d₁)
where:
$$N ( {d}_{1} ) = \frac{1}{\sqrt{2 π}} {\int }_{- ∞}^{{d}_{1}} {e}^{- \frac{{z}^{2}}{2}} d z$$
$${d}_{1} = \frac{ln ( \frac{S}{K} ) + ( r + \frac{{σ}^{2}}{2} ) ( T - t )}{σ \sqrt{T - t}}$$
S is the value of the actively managed portfolio
K is the strike price of the call option
r is the risk free interest rate
T−t is the time to maturity
σ is the volatility of returns of the actively managed portfolio
